(19) United States
(12) Patent Application Publication
(10) Pub. No.: US 2017/0255964 A1
(43) Pub. Date: Sep. 7, 2017

(54) CUSTOMER RESEARCH AND MARKETING ENGAGEMENT SYSTEM AND METHOD FOR INCREASING EARNINGS OPPORTUNITIES OF CONSUMERS

(71) Applicant: RYAN EARL HENDRICKS, SAN MATEO, CA (US)

(72) Inventor: RYAN EARL HENDRICKS, SAN MATEO, CA (US)

(21) Appl. No.: 15/452,576

(22) Filed: Mar. 7, 2017

Related U.S. Application Data
(60) Provisional application No. 62/304,687, filed on Mar. 7, 2016.

(51) Int. Cl. G06Q 30/02; G06Q 20/40

(52) U.S. Cl. CPC G06Q 30/0258; G06Q 20/40; G06Q 30/0264

(57) ABSTRACT

A customer research and marketing engagement system and a method for increasing earnings opportunities of consumers are disclosed. The system and method enable consumers to automatically earn money for sharing their personal data and for participating in business research. The system and method enable consumers to license (syndicate) access to information about themselves including real-time activities, in depth historical data on their physical and digital activities, interests, demographics, location-specific behavior, app interactions, transaction history and other actions via multiple channels using an online persona. The system and method allows the user to set rates for licensing access to their information and to closely manage their persona through a single portal that can be leveraged on an opt-in basis by marketers and researchers.

### CLAIM OF BENEFIT TO PRIOR APPLICATION

This application claims benefit to U.S. Provisional Patent Application 62/304,687, entitled “Customer Research And Marketing Engagement System And Method For Increasing Earnings Opportunities Of Consumers” filed Mar. 7, 2016. The U.S. Provisional Patent Application 62/304,687 is incorporated herein by reference.

### BACKGROUND

Embodiments of the invention described in this specification relate generally to consumer data collection and marketing, and more particularly, to a customer research and marketing engagement system and a method for increasing earnings opportunities of consumers.

Consumers have a wealth of personal information that companies want for marketing and sales engagement. As a result, consumer personal information is valuable to companies. The personal information wanted from consumers includes personal interests, demographics information, location-specific behavior, computer software or mobile application interactions consumers, transaction histories of consumers, and other information about consumer activities. Currently, it is common for companies to take personal information from consumers without their knowledge or permission. Such theft of personal data without compensation is profitable for companies. Yet despite the value of the personal information, the companies who take the consumer information frequently do not compensate the consumers.

In response, many consumers take certain actions to prevent unauthorized and uncompensated retrieval of their personal information. For instance, the vast majority of US consumers have blocked incoming communications using the FTC Do Not Call Registry (www.donotcall.gov) or other services to opt out of consumer information retrieval efforts of companies. For instance, consumers may block data retrieval attempts or opt out of providing location data, caller ID, and other information to requesting businesses and to prevent unwanted and irrelevant contact from third parties. As a result, consumers are often deprived of opportunities to earn money and other rewards from businesses for sharing valuable information about themselves.

Another problem with the existing state of personal consumer data retrieval is that consumers are often inundated with irrelevant communications from businesses. For example, some consumers are willing to be contacted by businesses to share information and perform tasks in exchange for payment and other rewards, but end up receiving poorly targeted, irrelevant communications (SPAM, telemarketing, in-app advertising, etc.). This wastes time and ties up limited communications channels.

Predictably, consumers quickly (or eventually) tired of receiving irrelevant communications and took actions to block such calls. Now there are too few available consumers for effective research, sales, and other activities by many companies. The small percentage of Americans who have not blocked contact to themselves via telecommunications and other channels (estimated at 10-15% of the United States population) makes it very difficult for businesses who generate revenue from research and other communications services to achieve their business targets. This is problematic for companies because it increases their costs and reduces the results from these engagements.

Another problem with the existing mechanisms with which businesses or companies retrieve personal consumer information is that they are plagued by poor response and conversion rates. Businesses that are able to successfully engage with consumers from time-to-time, are normally only able to gather a small portion of each consumer's profile including information that soon becomes outdated. Businesses are unable to cost-effectively maintain an up-to-date, accurate and complete source of data on customers and prospects.

Still other existing methods of paying and rewarding consumers for performing tasks or providing information about themselves are also problematic, incomplete, or otherwise undesirable. For instance, some of the existing methods limit the consumer's earning opportunities due to their static, single channel, non-automated capabilities for earning money and rewards. Also, existing systems and method are not able to create an effective consumer identity which the consumer can license to businesses.

Other problems with the existing systems and mechanisms include lack of a mobile wallet capability, making it more difficult and time-consuming for the consumer to receive and spend their earnings and rewards.

Therefore, what is needed is a way to disintermediate consumer personal information and control the consumer's own personal information via a syndicated persona (SP) or personal identity which the consumer can license (syndicate) to businesses for a recurring source of income.

### BRIEF DESCRIPTION

Methods for increasing earning opportunities of consumers and a customer research and marketing engagement system are disclosed. The customer research and marketing engagement system allows consumers to “license” access to themselves and their information at rates set by the consumers and to closely manage and control impressions of what is thought to be true about them through a single portal that can be leveraged on an opt-in basis used by marketers and researchers. The methods for increasing earnings opportunities of consumers significantly improve the volume and velocity of cash and benefit earning opportunities for consumers and greatly expand the options for earning by providing advanced controls for the consumer to decide who, what, how much, where, and when contact with consumer happens. The system and methods offer consumers powerful new research engagement scheduling control with day, time, and channel-specific pricing configuration settings and create real-time personas of the consumers for “broadcasting” in retail environments. The system and methods also support automated data collection and a mobile wallet for payments and point of sale purchases.

In some embodiments, the customer research and marketing engagement system includes a personal data marketing disintermediation service, a cognitive and predictive analytic-driven marketing service, and a cross-channel marketing and payments operations integration service.

In some embodiments, the customer research and marketing engagement system associates a consumer with a holistic consumer identity comprising an electronic mobile wallet, an engagement profile that includes a plurality of vendor engagement settings that manage vendor access to consumer personal data, and a syndicated persona (SP), a personal identity which the consumer can license to businesses for a recurring source of income. In some embodiments, the plurality of vendor engagement settings includes consumer configurable pricing rates, communication channels, and schedules that define a scope of engagement between a vendor and the consumer. In some embodiments, the engagement profile includes an option to toggle between (i) a live broadcast mode when the consumer is ready to engage and earn income or hear offers related to products and services and (ii) an inactive mode when the consumer intends to prevent engagement even when the vendor engagement settings would otherwise welcome vendor engagements and access to consumer personal data. In some embodiments, when the vendor engagement settings permit vendor contact with the consumer and the live broadcast mode is set on, then businesses, companies, retailers, and other such vendors can see the SP of the broadcasting consumer and engage with the consumer in real time for marketing, sales, research, and other business interactions.

In some embodiments, the customer research and marketing engagement system includes (i) an offer engagement learning engine (OELE) that implements an integrated predictive analytics and optimization algorithm to derive consumer insights from a consumer's SP, and (ii) a set of vendor campaign optimization components that maintain and monetize the consumer insights based on a comprehensive understanding of the consumer's wants and needs. In some embodiments, the customer research and marketing engagement system continuously supports a consumer in the consumer's interaction and engagement decision making efforts by way of the OELE and the set of vendor campaign optimization components to maintain and monetize the consumer insights. In this way, the customer research and marketing engagement system continually optimizes returns on investment (ROI) in marketing to consumers, enables vendors to create and manage targeted campaigns to consumers (both known consumers and anonymous individuals), and supports business growth of entities that administer the customer research and marketing engagement system.

In some embodiments, the method for increasing earnings opportunities of consumers includes steps for licensing access to personal information associated with a consumer, including real-time in depth historical data on physical and digital activities of the consumer, interests of the consumer, consumer demographics, location-specific behavior of the consumer, mobile app interactions by the consumer, transaction history of the consumer, and other actions via multiple communication channels, by using an online persona of the consumer. In this way, the method for increasing earnings opportunities of consumers enables the consumer to automatically earn money for sharing personal data of the consumer and for participating in business research.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now made to the accompanying drawings, which are not necessarily drawn to scale, and which show different views of different example embodiments.

FIG. 1 conceptually illustrates a process for increasing earning opportunities of a consumer and automatically paying the consumer for information about the consumer in some embodiments.

FIG. 2 conceptually illustrates an agent scan process in some embodiments.

FIG. 3 conceptually illustrates an agent negotiation process in some embodiments.

FIG. 4 conceptually illustrates an agent sequence and channel optimizing process in some embodiments.

FIG. 5 conceptually illustrates user options for scheduled access to communication channels for the user in a contact information and schedule configuration matrix in some embodiments.

FIG. 6 conceptually illustrates user options for configuring time blocks for access to communication channels of the user in a contact information and time block schedule configuration matrix in some embodiments.

FIG. 7 conceptually illustrates user price configuration options in a contact information and pay rate and per-day rate schedule configuration matrix in some embodiments.

FIG. 8 conceptually illustrates user options for merchant and data source configuration in some embodiments.

FIG. 9 conceptually illustrates a process for enhancing predictive algorithms in some embodiments.

FIG. 10 includes a block diagram that conceptually illustrates a customer research and marketing engagement system in some embodiments.

FIG. 11 conceptually illustrates a network architecture of a customer research and marketing engagement system in some embodiments.

FIG. 12 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some terminology is defined for the subject matter in this patent application. Specifically, for purposes of this disclosure, the phrase “syndicated persona” and/or “SP” is defined to mean a composite collection of past, present and predicted information about an individual (a persona) that is licensed (syndicated) to a business in exchange for money, benefits and/or other forms of value. In this way, a syndicated persona is a detailed consumer profile database that is continually updated and analyzed regarding what is known about the user's past and present activities in order to better match the consumer using predictive models with valuable business engagement opportunities (to earn money, discounts, and other value) based on their lifestyle, values, goals, interests, demographics, location-specific behavior, app interactions, transaction history and other activities.

Also, the term disintermediation in this disclosure means the removal of one or more intermediaries from the middle of a business process through the integration of more efficient and direct engagement of the stakeholders at the endpoints in business relationship chains. This is understood easily by an example in which the concept of intermediation begins with the acquisition of personal consumer data by a first party vendor (e.g., a bank with a direct consumer relationship) who then resells that information to a data consolidator (e.g., Acxiom) who then sells the consolidated consumer profile to a consumer data marketing services organization (e.g., Merkle) who then sells it on to the end business user (e.g., a luxury goods marketer like Victoria's Secret). Removal of one or more of the “middlemen” to enable the business marketer to more directly engage with the consumer captures the idea of disintermediation as used throughout this description of the inventive embodiments.

Some embodiments of the invention include a novel customer research and marketing engagement system and a method for increasing earnings opportunities of consumers. In some embodiments, the customer research and marketing engagement system includes a personal data marketing disintermediation service, a cognitive and predictive analytic-driven marketing service, and a cross-channel marketing and payments operations integration service.

In some embodiments, the customer research and marketing engagement system associates a consumer with a holistic consumer identity comprising an electronic mobile wallet, an engagement profile that includes a plurality of vendor engagement settings that manage vendor access to consumer personal data, and a syndicated personal identity (SP) which the consumer can license to businesses for a recurring source of income. In some embodiments, the plurality of vendor engagement settings includes consumer configurable pricing rates, communication channels, and schedules that define a scope of engagement between a vendor and the consumer. In some embodiments, the engagement profile includes an option to toggle between (i) a live broadcast mode when the consumer is ready to engage and earn income or hear offers related to products and services and (ii) an inactive mode when the consumer intends to prevent engagement even when the vendor engagement settings would otherwise welcome vendor engagements and access to consumer personal data. In some embodiments, when the vendor engagement settings permit vendor contact with the consumer and the live broadcast mode is set on, then businesses, companies, retailers, and other such vendors can see the SP of the broadcasting consumer and engage with the consumer in real time for marketing, sales, research, and other business interactions.

In some embodiments, the customer research and marketing engagement system includes (i) an offer engagement learning engine (OELE) that implements an integrated predictive analytics and optimization algorithm to derive consumer insights from a consumer's SP, and (ii) a set of vendor campaign optimization components that maintain and monetize the consumer insights based on a comprehensive understanding of the consumer's wants and needs. In some embodiments, the customer research and marketing engagement system continuously supports a consumer in the consumer's interaction and engagement decision making efforts by way of the OELE and the set of vendor campaign optimization components to maintain and monetize the consumer insights. In this way, the customer research and marketing engagement system continually optimizes ROI for consumers (e.g., a consumer's investment of time), enables vendors to create and manage targeted campaigns to consumers (both known consumers and anonymous individuals), and supports business growth of entities that administer the customer research and marketing engagement system.

In some embodiments, the method for increasing earnings opportunities of consumers includes steps for licensing access to personal information associated with a consumer, including real-time in depth historical data on physical and digital activities of the consumer, interests of the consumer, consumer demographics, location-specific behavior of the consumer, mobile app interactions by the consumer, transaction history of the consumer, and other actions via multiple communication channels, by using an online persona of the consumer. In this way, the method for increasing earnings opportunities of consumers enables the consumer to automatically earn money for sharing personal data of the consumer and for participating in business research.

In this specification, there are descriptions of processes or methods that are performed by software running on one or more computing devices (e.g., a desktop computer, a server, a laptop, a tablet computing device, a smartphone, a distributed network of computing and sensing devices, etc.) to enable consumers to set pay rates, select communication channels, and set scheduled times during which commercial entities may contact the consumers for information about the consumers at the rates specified by the consumers. In some cases, multiple software modules are deployed on multiple computing devices (both locally networked and inter-networked via distributed computing and/or cloud computing services), thereby allowing different commercial entities or intermediaries to work together to obtain desired consumer information at consumer-specified rates and times via consumer-selected communication channels, and to automatically pay the consumers according to the self-configured rates for access to the consumers' information. A variety of network configurations are described in greater detail below. However, it should be noted that for the purposes of the embodiments described in this specification, the word “method” is used interchangeably with the word “process”. Methods are described, therefore, by reference to example processes that conceptually illustrate steps of customer research and marketing engagement processes for automatically paying customers for information about themselves.

Several more detailed embodiments are described below. Section I generally describes automatically paying a consumer via mobile wallet for information about the consumer. Section II describes processes for increasing earnings opportunities of consumers by enabling consumers to configure a schedule, select channels of communication, and set pay rates for communication access to the consumers. Section III describes example user settings for channels, schedules, and rates. Section IV describes a customer research and marketing engagement system. Lastly, Section V describes an electronic system that implements some embodiments of the invention.

I. Automatically Paying a Consumer Via Mobile Wallet for Information about the Consumer

As stated above, personal data and information is routinely taken from consumers without knowledge, permission, or compensation. Companies who take the information often profit (directly or indirectly) from use of the personal information. Consumers take measures to block the unauthorized taking of such information by, for example, enlisting on the FTC Do Not Call Registry or by engaging other services to opt out of providing companies with physical location information, caller ID information, or other information. A number of problems, therefore, exist in the current scheme.

Specifically, one of the problems is that there is no effective way for consumers to be regularly compensated for providing their personal information to companies who request it and value it. Thus, consumers are deprived of opportunities to earn money and other rewards from businesses for sharing valuable information about themselves. On the other hand, the consumers who are willing to share information with companies have no effective way to block irrelevant communications. As a result, consumers who are willing to be contacted by businesses to share information and perform tasks in exchange for payment and other rewards, often receive poorly targeted, irrelevant communications (SPAM, telemarketing, in-app advertising, etc.) that waste their time and clog up their communications channels.

The current ineffective scheme also gives rise to problems on the side of companies and businesses. For instance, due to consumer disengagement efforts, there are too few available consumers for research, sales, and other activities. This cuts deeply into the ability of many such companies to generate revenue in line with business revenue goals. The companies suffer further from poor response and conversion rates in relation to the consumers willing to share personal information. For example, companies are generally able to obtain only a slice of a consumer's personal information (not a more comprehensive set of information which the company may desire). Moreover, the information that is obtained is quickly outdated in many cases. These problems increase costs for companies and reduce profits or other results from these engagements.

Embodiments of the customer research and marketing engagement system and the method for increasing earnings opportunities of consumers described in this specification solve such problems by enabling and incentivizing consumers to selectively unblock access to their personal information in exchange for payment and other rewards from interested businesses, companies, and/or organizations. In this way, consumers can get compensated or otherwise rewarded for providing detailed information about their personal interests, demographics, location-specific behavior, app interactions, transaction history and other activities. In some embodiments, the customer research and marketing engagement system comprises an interactive, multi-channel platform and mobile software application integrated with a secure mobile wallet that enables a consumer to charge companies for research related tasks and for the use of comprehensive information about the consumer's own individual interests, demographics, location-specific behavior, app interactions, transaction history and other activities in real-time.

In some other embodiments, the customer research and marketing engagement system is integrated with a secure mobile wallet provided by a third party. For example, the customer research and marketing engagement system may be used in connection with a user's previously established third party electronic wallet (e.g., an electronic wallet solution such as Apple Pay® by Apple® or Google Wallet™ by Google Inc.). Alternatively, the method for increasing earnings opportunities of consumers may be implemented as a modularized add-on component or plug-in that hooks into another mobile software application offered by a third party. For example, a third party application provider may include an implementation of the method for increasing earnings opportunities of consumers as an embedded feature of the application provided by the third party, or the third party application may provide run-time integration support for seamlessly running an instance of the method for increasing earnings opportunities of consumers.

The customer research and marketing engagement system and the method for increasing earnings opportunities of consumers described in this specification also solves the problem for businesses who are unable to effectively interact with consumers to perform multi-channel research, sales, marketing and advertising services due to the vast majority of such consumers opting out of communications and blocking contact to themselves.

Embodiments of the customer research and marketing engagement system and the method for increasing earnings opportunities of consumers described in this specification differ from and improve upon currently existing options. In particular, some embodiments of the customer research and marketing engagement system and the method for increasing earnings opportunities of consumers differ by enabling consumers to get paid or compensated in exchange for divulging personal information. For instance, a consumer may set a price for receiving a phone call from a company and for licensing insights (personal information of the consumer or insights that are based on or derived from the personal information of the consumer) included in the consumer's SP. In some embodiments, the SP includes a detailed composite of who the consumer is based on personal information the consumer has provided directly to businesses and other consumer information the system extracts from other sources within the consumer's control. In some embodiments, the customer research and marketing engagement system automatically licenses personal information at the direction and control of the consumer. In this way, consumers can get paid for providing personal information and for participating in research and marketing tasks, which are not limited to direct survey responses and other interactions, but also through the automatic sharing of data in real-time regarding the consumer's interests, location-specific behavior, app interactions, transaction history, the consumer's actions and for data about them collected from other apps and sources. In some embodiments, the automatic sharing of data in real-time is restricted to data sharing affirmatively permitted by the consumer, and data from different sources can be selectively permitted or not permitted for sharing by the consumer. The automatic sharing of data is such that the consumer simply needs to set permissions at some initial time and then, later, sharing of data is automatically handled with no effort or interaction of the user. This allows the consumer to automatically earn money without effort (e.g., “hands free”) by simply carrying about as normal while their persona is broadcast and personal information is retrieved from vendors at their previously-set pricing rates. On the other hand, consumers may wish to go about their day without always allowing access to their personal information, even when such consumers have previously scheduled the times for information access and set the pricing rates for information retrieval. In some embodiments, therefore, the consumer can still prevent the automatic and “permitted” sharing of data by toggling a live broadcast mode on and off, thereby automatically permitting sharing of data when broadcast mode is turned on, and preventing sharing of data when broadcast mode is turned off.

Thus, while there are existing systems from companies that may reward consumers for business-related research activities, the customer research and marketing engagement system and the method for increasing earnings opportunities of consumers described in this specification is more comprehensive in scope and provides more granularity of control over a consumer's own personal information, thereby empowering the consumer to decide how information is shared and to get paid for information they generate automatically. This granularity of control enables consumers to define, manage, control and license access to what is known and shared about themselves through their SP.

In addition, embodiments of the customer research and marketing engagement system improve upon the currently existing systems which lack a capability for users to control and license their personal identity for profit by interested agencies and which lack a means of enabling the user to control which information is collected and shared, and when the consumer wishes to interact and how much the consumer desires to be paid for different types of interaction (e.g., direct spoken telephone contact, email contact, question and answer surveys, etc.), timing of communication (e.g., the days, hours, minutes of availability or non-availability), and communication channels (e.g., phone, email, text, face-to-face, etc.) of information. The existing systems also lack a method for businesses to more profitably and continuously engage with consumer on a more complete and holistic basis beyond individual surveys and interactions. In contrast, the customer research and marketing engagement system improves on existing solutions by increasing earnings opportunities for consumers. In addition, the customer research and marketing engagement system increases earnings opportunities for consumers by integrating multiple channels, real-time access, automated data collection and a mobile electronic wallet for payments and purchases. In terms of earning opportunities, the customer research and marketing engagement system significantly improves the volume and velocity of cash and benefit earning opportunities for consumers. Furthermore, a consumer can easily “license” access to information about themselves and their personal profile via the SP at rates the consumer determines. Also, by using the customer research and marketing engagement system, the consumer can closely manage what is thought to be true about them through a single portal that can be leveraged on an opt-in basis by marketers and researchers.

The customer research and marketing engagement system and the method for increasing earnings opportunities of consumers of the present disclosure may be comprised of the following steps and/or elements. This list of possible constituent steps and/or elements is intended to be exemplary only and it is not intended that this list be used to limit the customer research and marketing engagement system and the method for increasing earnings opportunities of consumers of the present application to just these elements. Persons having ordinary skill in the art relevant to the present disclosure may understand there to be equivalent steps and/or elements that may be substituted within the present disclosure without changing the essential function or operation of the customer research and marketing engagement system and the method for increasing earnings opportunities of consumers.

1. Installation: A consumer downloads a mobile software application (“mobile research money-making app” or simply “mobile app”) that implements the method for increasing earnings opportunities of consumers and installs the mobile app on a mobile computing/communication device, such as a smartphone. While the mobile app is installing on the mobile device, the customer research and marketing engagement system integrates the mobile app software with a secure mobile wallet app (e.g., Apple Pay® by Apple® or Google Wallet™ by Google Inc.). In some cases, the method for increasing earnings opportunities of consumers is implemented in a mobile application of a third party provider. For example, installation of the mobile app may include an option to install a module for increasing earnings opportunities of consumers.

2. App/Wallet Configuration: After installation, the consumer user configures settings of the mobile app and mobile wallet, including app permissions, user preferences regarding when (day of week, time of day, etc.) and how they can be contacted (email, phone, text, etc.) and how much they require in terms of payment for the different days, times and types of contact.

3. Extensive Personal Data Retrieval: the customer research and marketing engagement system captures and analyzes data on consumer behavior beginning with installation and configuration based on permissions granted by the consumer user to access and use personal information shared by the consumer user directly and/or acquired indirectly from other sources (including other device-resident apps from which the customer research and marketing engagement system may access information).

4. Secure Mobile Wallet Integration: the customer research and marketing engagement system integrates with a secure mobile wallet (from an entity that has deployed the customer research and marketing engagement system for use, or from another entity that provides mobile wallets) to enable the consumer user to use a secure stored value payment device (e.g., a prepaid card) and/or to add their own existing loyalty and payment method(s) for use in transactions (e.g., credit and/or membership card) made through the customer research and marketing engagement system.

5. Syndicated Persona: the customer research and marketing engagement system creates and registers a unique multi-channel “Syndicated Persona” (SP), a detailed consumer user profile database and registry that is continually updated and analyzed regarding what is known about the consumer user in order to better match the consumer user in real-time with earning opportunities based on their interests, demographics, location-specific behavior, app interactions, transaction history, and other activities.

6. Personal Research Contact Channels: the customer research and marketing engagement system creates or registers one or more unique contact channel(s) and ID(s) per the consumer user's request including phone, email, chat, social media, postal mail, and/or other available channels.

7. Money-making Offer and Benefit Matching Analytics: the customer research and marketing engagement system matches the consumer user's SP with available earning opportunities by analyzing the consumer user's information from direct and indirect sources, the available offer characteristics and the consumer user's prior interaction history.

8. Offer Selection and Prioritization: the customer research and marketing engagement system selects and prioritizes one or more targeted offers and presentment channels.

9. Offer Presentment: the customer research and marketing engagement system presents the consumer user with one or more targeted offers through the relevant channel(s). A live broadcast mode can be set when the consumer user is ready to engage and earn income or hear offers related to products and services or it can be set to an inactive mode when the consumer intends to prevent engagement.

10. Offer Acceptance: the consumer user accepts or rejects contact presented by the customer research and marketing engagement system.

11. User Engagement and Response(s): when a consumer user accepts an offer, the customer research and marketing engagement system initiates the engagement process with the consumer user and guides the consumer user to respond to relevant questions, review content and provide opinions, and/or take actions such as to visit a retail establishment, interact with digital content, join in a focus group, and other relevant actions, as needed.

12. Engagement Tracking: the customer research and marketing engagement system records the successful completion of the required action.

13. Alternate Engagement Options: when a consumer user rejects an offer for some reason, the customer research and marketing engagement system provides the consumer user with options including alternate offers, alternate channels, alternative day and/or time, or options to perform other sponsored activities.

14. Follow-on Offers: when the consumer user requests a follow-on engagement after successfully completing the prior offer, the customer research and marketing engagement system applies analytics to identify and recommend the next best offer based on the consumer user's response and history. The customer research and marketing engagement system of some embodiments then re-initiates an engagement process between the offering entity and the consumer user.

15. Engagement Validation: when the consumer user completes each paid engagement, the customer research and marketing engagement system processes the sponsor's or vendor's acceptance or rejection of the consumer user's interactions based on a set of agreed rules of engagement.

16. Debit-Credit Settlement: when an engagement is successfully completed, the customer research and marketing engagement system processes debit(s) and credit(s) to each consumer user and settles as agreed with other stakeholder accounts (vendors, businesses, companies, sponsors, entities that deploy and/or administrate the customer research and marketing engagement system, and other third party stakeholders, such as third party electronic wallet providers, e.g., Apple Pay® by Apple® or Google Wallet™ by Google Inc.).

17. Use of Earned Funds: the consumer user may use or transfer the funds and/or rewards earned by presenting their mobile wallet and payment information at a digital or physical point of sale (POS) for either automated scanning or manual input.

18. Engagement Learning Engine: the consumer user's SP and advanced analytics system continually improves user interaction success rates through the use of an offer engagement learning engine (OELE), a cognitive learning engine based on an integrated predictive analytics and optimization algorithm system that is continuously supporting the user interaction decision making process.

19. Continuous Earning and Sponsor or Vendor Benefit Optimization: The customer research and marketing engagement system OELE and campaign optimization components continually optimize returns on investment (ROI) for consumer users (who invest time), enables vendors (their sponsorship investment) to create and manage targeted campaigns to consumers (both known consumers and anonymous individuals), and supports business growth of entities that administer the customer research and marketing engagement system.

The various steps and/or elements of the customer research and marketing engagement system and the methods for increasing earnings opportunities of consumers described in the present disclosure may be related in the following exemplary fashion. It is not intended to limit the scope or nature of the relationships between the various steps or elements and the following examples are presented as illustrative examples only.

Step 1 and Step 2: Completion of the installation of the mobile app and integration with a secure mobile wallet in Step 1 triggers the Step 2 request for the consumer user to configure the app permissions to access other apps, to establish user contact channels, populate the available days and times schedule and to set preliminary rates. These settings can be changed later.

Step 1 and Step 4: The mobile app installed in Step 1 enables the secure addition of personal loyalty and payment vehicles (credit cards, etc.) by the consumer user to the wallet used by the mobile app in Step 4.

Step 1 and Step 10: The mobile app installed in Step 1 enables the software to immediately record and respond to the consumer user's acceptance or rejection of the offer to earn money in Step 10.

Step 2 and Step 3: User permissions granted in Step 2 enable the collection of personal consumer data by the customer research and marketing engagement system in Step 3.

Step 2 and Step 6: User preferences set in Step 2 enable the customer research and marketing engagement system to create private contact channels for the consumer user in Step 6.

Step 2 and Step 7: User permissions granted in Step 2 enable the customer research and marketing engagement system to match relevant targeted offers in Step 7 based on consumer user insights analysis.

Step 3 and Step 5: Personal consumer data collected in Step 3 enables the creation of a “Syndicated Persona” (SP) database and registry of the customer research and marketing engagement system user insights in Step 5.

Step 4 and Step 12: Integration with a secure mobile wallet in Step 4 enables secure engagement tracking in Step 12.

Step 4 and Step 16: Integration with a secure mobile wallet in Step 4 enables debit-credit settlement in Step 16.

Step 4 and Step 17: Integration with a secure mobile wallet in Step 4 enables earned funds to be spent or transferred in Step 17.

Step 5 and Step 7: Creation of the “Syndicated Persona” (SP) in Step 5 enables the matching of relevant offers to individual consumer users in Step 7.

Step 5 and Step 8: Creation of the “Syndicated Persona” (SP) in Step 5 enables Offer selection and prioritization for Step 8.

Step 5 and Step 18: Creation of the “Syndicated Persona” (SP) in Step 5 enables the customer research and marketing engagement system to continuously improve the insights gathering and application processes in Step 18.

Step 6 and Step 9: Contact channels created in Step 6 enable the offer presentment channel(s) for Step 9.

Step 6 and Step 13: Contact channels created in Step 6 enable alternate channel engagement options to be presented for Step 13.

Step 7 and Step 8: Offer matching analytic algorithms executed in Step 7 enable Offer selection and prioritization for Step 8.

Step 7 and Step 13: Offer matching analytics performed in Step 7 enable the identification of alternate offers for Step 13.

Step 8 and Step 13: Offer selection and prioritization in Step 8 enables alternate Offers to be presented for Step 13.

Step 8 and Step 14: Offer selection and prioritization in Step 8 enables the selection of follow-up offers for Step 14.

Step 9 and Step 10: Offer presentment in Step 9 enables offer acceptance in Step 10.

Step 10 and Step 11: Offer acceptance in Step 10 enables user engagement and response in Step 11.

Step 11 and Step 12: Offer engagement and response in Step 11 enables secure engagement tracking in Step 12.

Step 12 and Step 15: Secure engagement tracking in Step 12 enables engagement validation in Step 15.

Step 16 and Step 17: Debit-Credit settlement performed in Step 16 enables consumer users to use earned funds and/or rewards as described in Step 17.

Step 18 and Step 19: Use of the engagement learning engine in Step 18 enables the customer research and marketing engagement system to optimize returns on investment (ROI) in Step 19.

The general description above demonstrates how consumers can “license” access to themselves and their information at self-set pay rates, thereby allowing consumers to earn money and significant benefits automatically on purchases via the autonomous persona agent which locates data on consumers across all digital channels and to reduce irrelevant communications from businesses across all communication channels. The descriptions above also reveal how consumers can use software implementations of the methods to price and manage access by businesses to the data of the consumers for purposes of marketing, research, and in-store engagement, as well as allowing consumers to control impressions of what is thought to be true about them (e.g., their interests, behaviors, demographics, econometrics, and other such personal information) through their digital personas (the syndicated persona of a consumer) via a single portal that can be leveraged on an opt-in basis used by marketers and researchers. The methods and system also prevent unauthorized and/or unpaid access to consumer data which may be present on or in data sources of the consumer, such as data on social media sites or on mobile devices, and enable the consumer to get paid for their data from transactions, app usage, surveys, retail vendor interaction, location, activities, and other sources of personal data.

Businesses, vendors, and sponsors also benefit from the methods and system described above by gaining more predictable and complete access to more comprehensive, relevant and up-to-date consumer data via the syndicated personas of consumers. This allows for better applications in research, marketing, support, and other business purposes. In addition, the methods and system enable businesses to lower costs of relevant consumer data acquisition and increase ROI of direct engagement with consumers via the private, permitted, and syndicated platform supported by the customer research and marketing engagement system and the methods for increasing earnings opportunities of consumers.

Overall, this results in improvements in the volume and velocity of cash and benefit earning opportunities for consumers, while reducing or eliminating irrelevant communications. In the next section, several examples of methods for increasing earning opportunities of consumers and for automatically paying those consumers are described.

II. Processes for Automatically Paying Customers for Information about Themselves

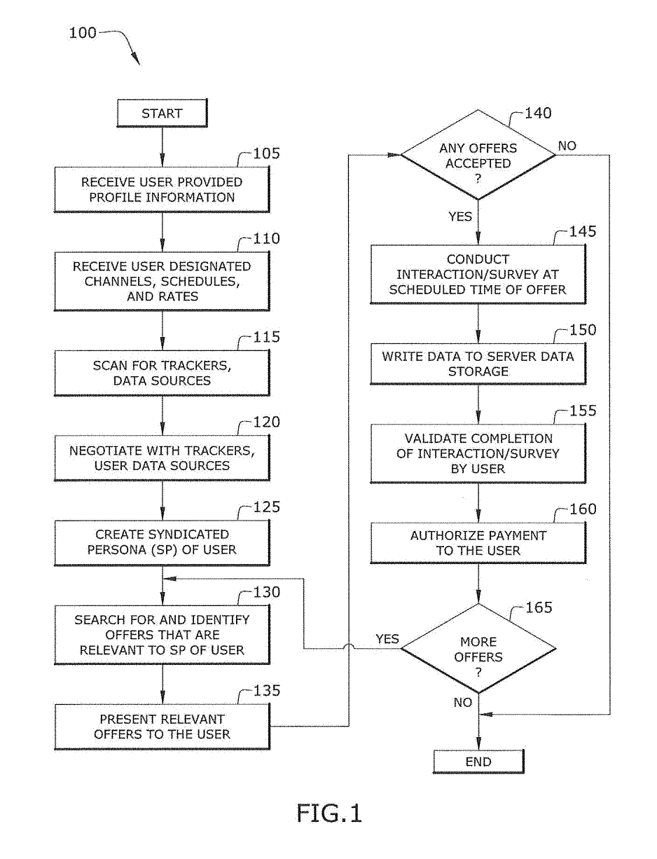

By way of example, FIG. 1 conceptually illustrates a process 100 for increasing earning opportunities of a consumer and automatically paying the consumer for information about the consumer. As shown in this figure, the process 100 starts when a consumer or customer (in this example referred to as the “user”) sets up a user profile with general user information and specific communication access configuration settings (e.g., communication channels, pay rates, and schedule of availability). In some embodiments, the process 100 receives (at 105) user provided profile information. The user provided profile information includes general information pertaining to the user's identity and location or how to reach the user. Examples of user identity information include, without limitation, birth date, gender, height, weight, level of education, employment status, marital status, children (if any) and each child's age, political affiliation (if any), ethnicity, etc. Additional user information may round out the user identity information, including, without limitation, products (e.g., mobile device(s), wireless carrier, computer(s), vehicle(s), service(s), etc. The user profile also includes information about how to reach the user or the user's location. Examples of information about how to reach the user and the user location information include, without limitation, email address(s) and associated password(s), residence address and ownership status, specific telephone number for commercial entities to call to reach the user, other telephone numbers or email addresses, chat IDs, fax number (if any), payment account information, etc.

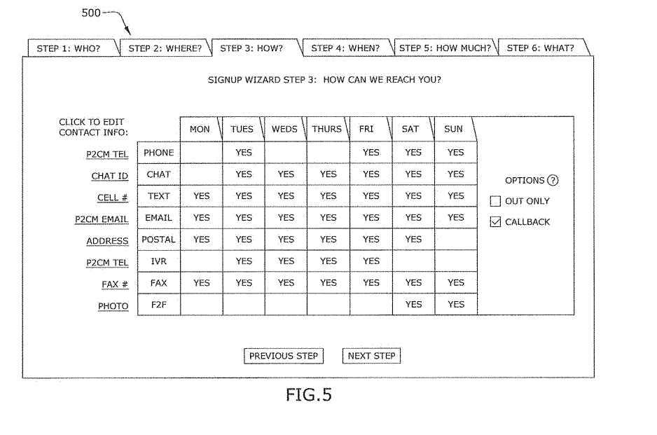

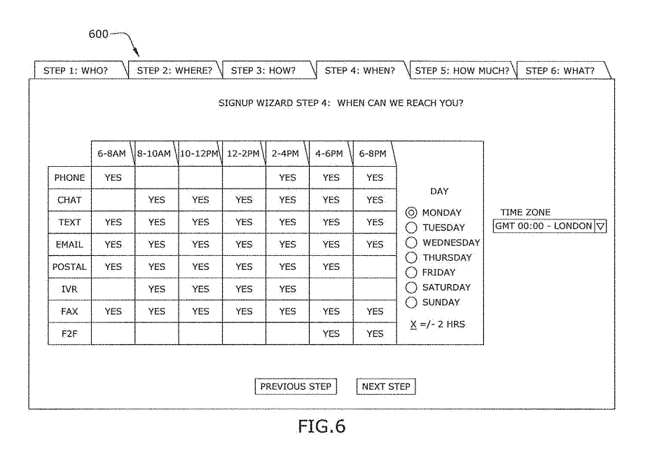

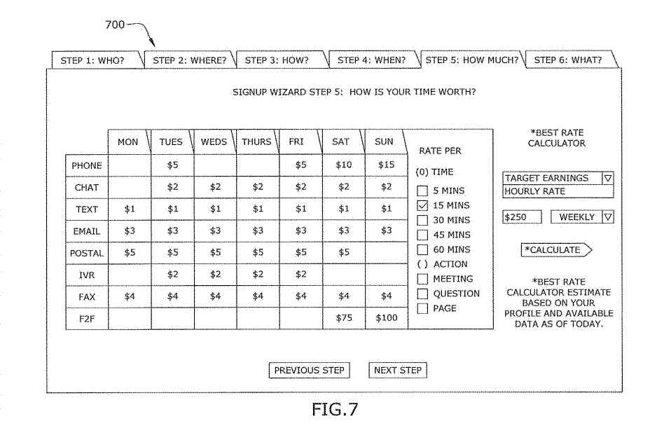

After receiving the user provided profile information, the process 100 of some embodiments receives (at 110) user designated communication channels, communication availability schedules, and pay rates. Specifically, the communication channels selected by the user are configured according to scheduled access days for each channel. Additional details of how a user configures the communication channels according to scheduled access days is described in detail below by reference to FIG. 5. The communication availability schedules are configured by the user according to blocks of time during a day for each communication channel. Additional details of how a user configures the communication availability schedules is described in detail below by reference to FIG. 6. The pay rates are set by the user per channel based on the day on which the communication channel is available. Additional details of how a user sets pay rates is described in detail below by reference to FIG. 7.

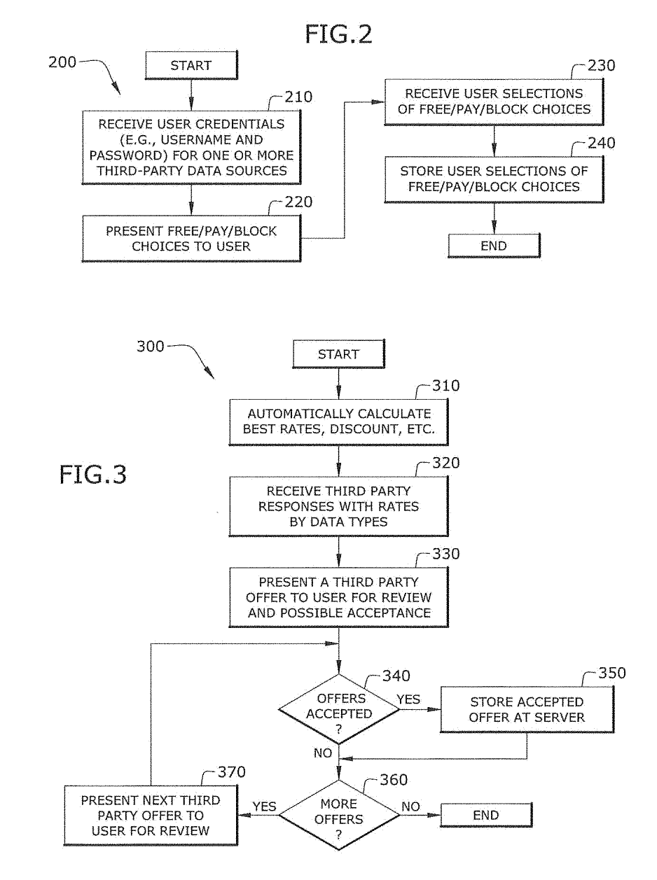

After receiving the user designated communication channels, communication availability schedules, and pay rates, the process 100 of some embodiments scans (at 115) for trackers and data sources. As the consumer has provided the configuration options to allow a certain amount of permitted tracking, the next step is to review those trackers designated by the consumer to have such permission. Scanning for trackers and data sources is described in greater detail below by reference to FIG. 2.

In some embodiments, the process 100 includes a step for negotiating (at 120) with trackers and user data sources. Negotiating with trackers involves analytics-optimized pricing which identifies the best rate for a consumer to charge for engaging with businesses based on their individual profile characteristics. Negotiating with trackers and user data sources is described in greater detail below by reference to FIG. 3.

In some embodiments, the process 100 creates (at 125) a syndicated persona of the user. A “Syndicated Persona” (SP) (otherwise referred to as a “Syndicated Personal Identity” and abbreviated by the acronym “SP”) is a unique detailed multi-channel consumer user profile database and registry that is continually updated and analyzed regarding what is known about the consumer user in order to better match the consumer user in real-time with earning opportunities based on their interests, demographics, location-specific behavior, app interactions, transaction history, and other activities.

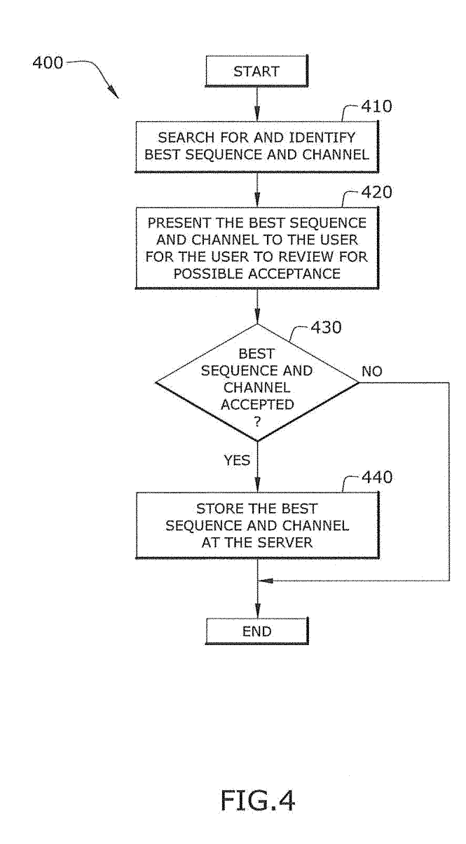

In some embodiments, the process 100 searches for and identifies (at 130) offers that are relevant to the SP of the user. In searching for and identifying relevant offers, the process 100 of some embodiments predicts relevant, timed offers by modeling ideal offers in priority to present to a consumer in a relevant location at a certain day and time. In some embodiments, a process is performed to find the most optimized sequence and channel to present offers to the user. Find the best (most optimal) sequence and channel to present to the user for relevant offers is described in detail below by reference to FIG. 4.

Next, the process 100 of some embodiments presents (at 135) relevant offers to the user. The relevant offers may be presented in an optimized sequence and best channel, according to sequence optimization steps such as those described by reference to FIG. 4. When the offers are presented, the user may accept or decline offers, even when offers are made during scheduled availability by way of a communication channel set by the user and at the user-specified pay rate. Therefore, the process 100 of some embodiments optimizes contact channel delivery, such that ideal channels or sequences of channels are identified for communicating with the consumer at a certain day or time. The process 100 of some embodiments then maximizes the timing, sequence, and delivery of the relevant offers by identifying the ideal sequence of offers and presenting the offers according to the ideal sequence in an effort to optimize the results of consumer interactions.

In some embodiments, the process 100 determines (at 140) whether any offers have been accepted by the user. When one or more offers are accepted, the process 100 transitions to step 145, which is described further below. On the other hand, when no offers are accepted, the process 100 ends.

As noted above, when an offer is accepted by the user, the process 100 includes a step for conducting (at 145) an interaction and/or survey at the scheduled time of the offer. When the interaction/survey is completed, the process 100 writes (at 150) data about the interaction/survey conducted with the user to a data storage of a server. In some embodiments, the process 100 then validates (at 155) completion of the interaction/survey by the user. After completion of the interaction/survey is validated, the process 100 authorizes (at 160) payment to the user. As noted above, the payment to the user is based on the agreed payment of the offer, which is at least a payment price that meets the user-specified pay rate for the scheduled interaction/survey time.

In some embodiments, the process 100 determines (at 165) whether there are more offers will be searched for to present to the user. When more offers will be searched for, then the process 100 returns to step 130 to search for and identify offers that are relevant to SP of the user, which was described in detail above. On the other hand, when no more offers will be searched for, then the process 100 ends.

Several detailed example processes of specific steps of the process 100 are described next by reference to FIGS. 2-4. In particular, FIG. 2 conceptually illustrates an agent scan process 200. The agent scan process 200 includes several steps for completing step 115 of the process 100, which was described above by reference to FIG. 1. As shown in this figure, the agent scan process 200 receives (at 210) user credentials for one or more third-party data sources. For example, the user may provide a username and a password for a social or media platform.

In some embodiments, the agent scan process 200 presents (at 220) choices for the user to set in relation to the third-party data sources, including at least one “free” choice, one “pay” choice, and one “block” choice. Next, the agent scan process 200 receives (at 230) user selections of the choices (e.g., “free”, “pay”, “block”) for the third-party data sources. After the user-selected choices are made, the agent scan process 200 stores (at 240) the user selections of the tracker and data source choices in relation to the user profile. Then the agent scan process 200 ends.

Turning to another example, FIG. 3 conceptually illustrates an agent negotiation process 300. The agent negotiation process 300 includes several steps for completing step 120 of the process 100, which was described above by reference to FIG. 1. As shown in this figure, the agent negotiation process 300 starts by automatically calculating (at 310) the best rates, discounts, etc. In some embodiments, one or more predictive algorithms are employed to make one or more estimates or predictions as to best rates for a user, discounts that may associate with a user, etc.

After calculating the best rates, discounts, etc., the agent negotiation process 300 receives (at 320) third party responses with rates by data types. In some embodiments, the agent negotiation process 300 then presents (at 330) a third party offer to the user for review and possible acceptance. Next, the agent negotiation process 300 determines (at 340) whether any offers have been accepted. When offers have not been accepted, the agent negotiation process 300 transitions to step 360, described below. On the other hand, when offers have been accepted, then the agent negotiation process 300 stores (at 350) the accepted offers at the server data storage. Then the agent negotiation process 300 transitions to step 360.

In some embodiments, the agent negotiation process 300 determines (at 360) whether there are more offers. When there are more offers, then the agent negotiation process 300 transitions back to step 340, which was described above. On the other hand, when the agent negotiation process 300 determines (at 360) that there are no more offers, then the agent negotiation process 300 ends.

FIG. 4 provides an example of optimizing the sequence and channel of the presentation of the relevant offers to the user. In some embodiments, the steps for optimizing the sequence may occur following step 130 or right before step 135 of the process 100, which is described above by reference to FIG. 1. In particular, FIG. 4 conceptually illustrates an agent sequence and channel optimizing process 400. As shown in this figure, the agent sequence and channel optimizing process 400 starts by searching for and identifying (at 410) the best sequence and channel. After the search, the agent sequence and channel optimizing process 400 presents (at 420) the best sequence and channel to the user for the user to review for possible acceptance. Thus, the agent sequence and channel optimizing process 400 determines (at 430) whether the best sequence and channel has been accepted. When the agent sequence and channel optimizing process 400 determines that the best sequence and channel have not been accepted, then the agent sequence and channel optimizing process 400 ends. On the other hand, when the agent sequence and channel optimizing process 400 determines that the best sequence and channel have been accepted, the agent sequence and channel optimizing process 400 then stores (at 440) the best sequence and channel in the data storage of the server. Then the agent sequence and channel optimizing process 400 ends.

### III. User Settings for Channels, Schedules, and Rates

In relation to the process 100 described by reference to FIG. 1, above, a user is able to self-configure several items which individually and collectively allow the user to control their syndicated persona (SP) in ways the limit access to the user's own information. The following example describes how the user-supported communication channels (i.e., those communication channels selected by the user) are configured according to scheduled access days for each channel. The example is described by reference to FIG. 5, which conceptually illustrates user options for configuring scheduled access to communication channels of the user in a contact information and schedule configuration matrix 500. As shown in this figure, the contact information and schedule configuration matrix 500 allows the user to edit contact items that are associated with several communication channels (e.g., phone, chat, text, email, postal, IVR, fax, etc.). The contact information and schedule configuration matrix 500 also lists the days of the week, from Monday to Sunday. The matrix then can be seen to include user access status for each day by each communication channel. For example, the user can be reached by phone on Tuesday, Friday, Saturday, and Sunday, while it is possible to reach the user by chat on Tuesday, Wednesday, Thursday, Friday, Saturday, and Sunday. Similarly, the user may be contacted by text (SMS) message, email, and fax every day. The remaining communication channels also specify the days of the week on which it may be possible to reach the user.

Turning to another example, FIG. 6 conceptually illustrates user options for configuring time blocks for access to communication channels of the user in a contact information and time block schedule configuration matrix 600. As shown in this figure, the contact information and time block schedule configuration matrix 600 allows the user to specify availability for each communication channel for each day of the week. Specifically, the contact information and time block schedule configuration matrix 600 includes several time blocks (e.g., 6-8 am, 8-10 am, 10-12 pm, 12-2 pm, 2-4 pm, 4-6 pm, and 6-8 pm). Each communication channel can be configured by the user to allow for access (YES) or not (blank). Days of the week can be changed by selection one of the radio buttons associated with the days of the week.

In the next figure, self-configured pay rates are shown in a contact information and pay rate and per-day rate schedule configuration matrix 700, as described in detail by reference to FIG. 7. In other words, the pay rates are set by the user per channel based on the day on which the communication channel is available. Additional options for configuring user pay rates are shown in several rate per time check boxes. The rate per time check boxes include 5 minutes user access time, 15 minutes rate per time check boxes, 30 minutes rate per time check boxes, 45 minutes rate per time check boxes, 60 minutes rate per time check boxes, and other options. Also shown in this figure is a best rate calculator which automatically determines a user's best pay rate given some initial input, such as target earnings, hourly rate, etc. Specifically, the best rate calculator is based on analytics-optimized pricing of the pay rate for the consumer. The analytics-optimized pricing identifies the best rate for a consumer to charge for engaging with businesses based on their individual profile characteristics.

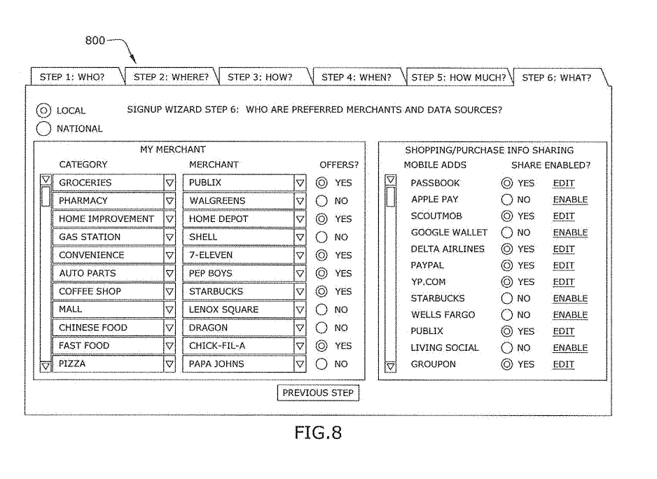

Next, FIG. 8 conceptually illustrates user options for merchant and data source configuration 800. As shown in this figure, the user has a wide range of configuration options, including geographical scope (e.g., local or national), merchant categories (e.g., groceries, pharmacy, home improvement, gas station, convenience, auto parts, coffee shop, mall, Chinese food, fast food, and pizza (and more by scrolling down). Also, each category type can be configured to have a preferred merchant to which offers are to be tracked and offered or not. In this figure. On the right side of this figure is the data sources window options, where options can be specified for mobile adds and making them share-enabled.

### III. Offer Engagement Learning Engine

An offer engagement learning engine (OELE) is integrated into the customer research and marketing engagement system of the some embodiments. In some embodiments, the OELE performs a process for continually improving user interaction success rates. In some embodiments, the process for continually improving user interaction success rates occurs after completion of the process for increasing earning opportunities of a consumer and automatically paying the consumer for information about the consumer, which is described above by reference to FIG. 1. In some other embodiments, the process for continually improving user interaction success rates runs contemporaneously with the process for increasing earning opportunities of a consumer and automatically paying the consumer for information about the consumer or other processes performed in relation to the customer research and marketing engagement system, thereby continuously supporting the user interaction decision making process.

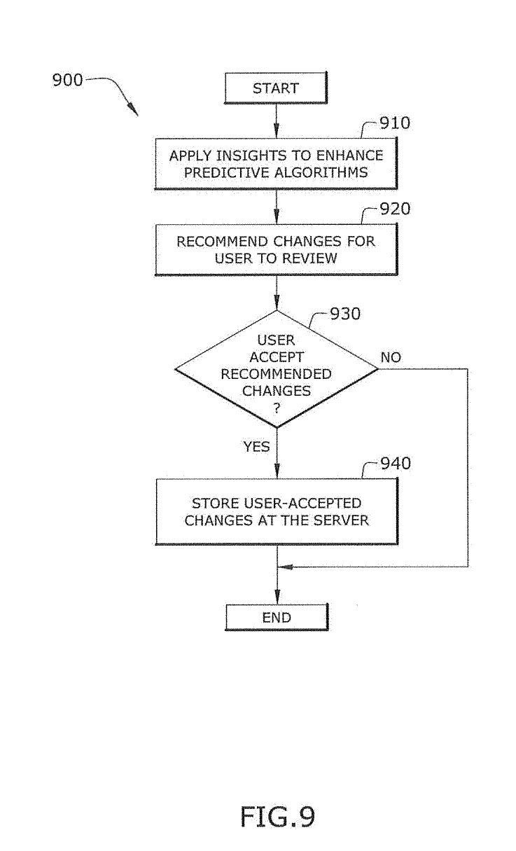

By way of example, FIG. 9 conceptually illustrates a process 900 for enhancing predictive algorithms in some embodiments. As shown in this figure, the process 900 starts by applying (at 910) insights to enhance predictive algorithms. In some embodiments, the process 900 applies insights with respect to an offer engagement learning engine (OELE), which is an integrated predictive analytics and optimization algorithm based system that continuously supports the user decision making process. In supporting the user, the process 900 of some embodiments recommends (at 920) changes for the user to review. Next, the process 900 determines (at 930) whether the user has accepted the recommended changes. When the user has accepted the recommended changes, the process 900 stores (at 940) the user-accepted changes in a data storage of the server, and then the process 900 ends. On the other hand, when the process 900 determines (at 930) that the user has not accepted the recommended changes, then the process 900 ends.

### IV. Customer Research and Marketing Engagement System

The customer research and marketing engagement system of the present disclosure provides a platform that works by operation of one or more computing devices with processors on which one or more computer programs run to carry out instructions which individually implement parts of the method for increasing earnings opportunities of consumers or which collectively implement the method for increasing earnings opportunities of consumers.

In some embodiments, the customer research and marketing engagement system combines an interactive multi-channel software application (or mobile app) with scalable and secure database technology, a cognitive and predictive analytics software engine, mobile wallet functions and location-aware messaging and communications management services to deliver income-generating opportunities to consumers and improved customer engagement to businesses. By way of example, a user may download and install software to run locally on a computing device that accesses one or more server computing devices to register or activate a new account (if needed), log into the system, enable personal data to be shared, set rates for sharing personal data, set communication and contact channels (e.g., email, text, phone, etc.), set schedules (e.g., hours, days, other customizable times, etc.) of availability, enable or disable live broadcasting of the unique persona of the user (e.g., the SP and personal information of the consumer is broadcast to vendors when the user is ready to engage and/or make purchases of products or services), etc.

In some embodiments, the customer research and marketing engagement system then gathers data about the user's interests, demographics, location-specific behavior, app interactions, transaction history and other activities. Based on the data gathered about the user, the customer research and marketing engagement system of some embodiments then creates or updates the SP (specifically, the “Syndicated Persona”) associated with the user. The SP, therefore, is a composite collection of past, present and predicted information about an individual (a persona) that is licensed (syndicated) to a business in exchange for money, benefits, and/or other forms of value. Each individual user is associated with a unique SP which includes information gathered in relation to the specific user, thereby enabling an accurate and up-to-date detailed dynamic consumer profile associated with the present user to be selectively broadcast and syndicated for scheduled and payed interactions and/or communications.

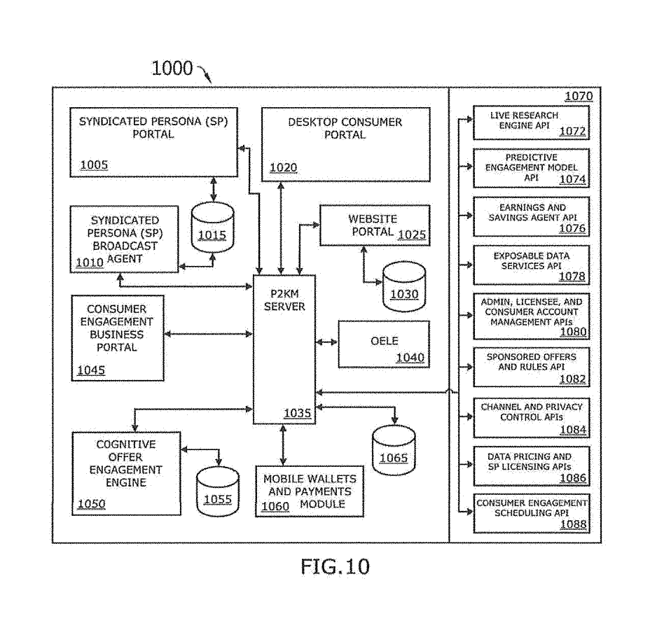

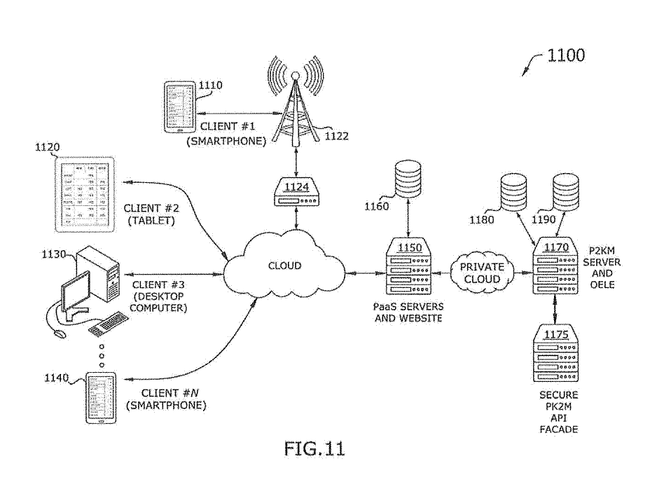

By way of example, a block diagram shown in FIG. 10 conceptually illustrates a customer research and marketing engagement system 1000. As shown in this figure, the customer research and marketing engagement system 1000 includes several portals, agents, servers, computational or prediction engines, databases, and an application programming interface (API) 1070 that includes a plurality of API libraries for third party and other entity interaction with the customer research and marketing engagement system 1000.

Specifically, the customer research and marketing engagement system 1000 includes a syndicated persona (SP) portal 1005, a syndicated persona (SP) broadcast agent 1010, a syndicated persona (SP) database, a desktop consumer portal 1020, a website portal 1025, a website and user authentication database 1030, a P2KM server 1035, an offer engagement learning engine (OELE) 1040, a consumer engagement business portal 1045, a cognitive offer engagement engine 1050, a sponsored offers database 1055, a mobile wallets and payments module 1060, a syndicated persona database of consumer insights 1065, and an application programming interface (API) 1070 that includes a plurality of API libraries 1072-1088 for third party and other entity interaction with the customer research and marketing engagement system 1000. The plurality of API libraries 1072-1088 include a live research engine API 1072, a predictive engagement model API 1074, an earnings and savings agent API 1076, an exposable data services API 1078, a set of administrative, licensee, and consumer account management APIs 1080, a sponsored offers and rules API 1082, channel and privacy control APIs 1084, data pricing and syndicated persona (SP) licensing APIs 1086, and a consumer engagement scheduling API 1088.

In some embodiments, the focal center of the customer research and marketing engagement system 1000 is the P2KM server 1035 which provides the capabilities, connectivity and web services for campaign management, messaging channels, predictive modeling, accounting and billing, security, API management, trusted service management, data visualization, reporting, workflow management and image processing.

The website portal 1025 and the user authentication database 1030 provide user authentication for computing devices or mobile devices connecting to the website portal 1030. The website portal 1030 is a primary entry point into the customer research and marketing engagement system 1000 where users, sponsors, other third parties and administrators can log in to manage their data and account settings. However, an app can be installed that is able to access the customer research and marketing engagement system 1000 and integrated with device systems, 3rd party wallets, apps and data source and other channels.

The offer engagement learning engine (OELE) 1040 enables continuous consumer interaction optimization using advanced analytics and cognitive tools. The syndicated persona database includes in-depth consumer data and insights available for licensing and engagement by sponsors. The sponsored offers database 1055 is connected to the cognitive offer engagement engine 1050 and is uploaded by sponsors with details regarding offer content, offer interaction rules and logic, consumer SP targeting, scheduling, channels, and more. Mobile wallets and payments module 1060 enables users to earn cash and benefits when spending money at retail point of sale (POS) terminals.

The plurality of API libraries 1072-1088 enable third parties to connect to the customer research and marketing engagement system 1000 effortlessly. In particular, the live research engine API 1072 enables direct, real-time engagement with users, the predictive engagement model API 1074 enables continuous improvement of user engagement, the earnings and savings agent API 1076 enables automatic optimization of offers for all parties, the exposable data services API 1078 provides sponsors and third parties with actionable insights, the set of administrative, licensee, and consumer account management APIs 1080 provide user account management, rights, and settings, the sponsored offers and rules API 1082 enables access to and analysis of offers, the channel and privacy control APIs 1084 are focused on what users will share and in which situations, the data pricing and syndicated persona (SP) licensing APIs 1086 for all parties, and the consumer engagement scheduling API 1088 to control timing by channel.

The customer research and marketing engagement system 1000 is a data-driven and user-configurable platform for valuing and monetizing individual user information and data. Thus, while the consumer user will be focused on managing their own personal data, accounts and settings, the third party partner or sponsor user will need to be able to customize the app for their users with specific capabilities, branding, user options and more. An administration user will need secure access for managing third parties, monitoring security, fraud, privacy and overall administration of predictive engagement models and autonomous earnings and savings agent capabilities.

The user information and data includes data obtained from traditional survey forms (e.g., delivered to a mobile computing device, such as a smartphone, of a willing consumer) and Q&A sessions (e.g., delivered to a consumer via email or conducted over the phone with the consumer). Other data and information is obtained in other ways, as well. Specifically, the customer research and marketing engagement system of some embodiments extracts relevant data automatically from sources which the consumer/user has granted data sharing permissions. An example of such a data source would be other applications resident on the computing device on which the consumer/user has installed the software in connection with the customer research and marketing engagement system. When the user has permitted such data sharing of other applications or other computing devices with other applications, the customer research and marketing engagement system may obtain interaction histories from the applications or devices, as well as from other available sources that are connected to the network on which the customer research and marketing engagement system is deployed and operates (e.g., the Internet).

The sources from which data and information can be extracted or obtained include, without limitation, electronic devices or machines, automobiles, appliances, etc. Each of the sources may include devices or components that allow information and data to be gathered and shared with the customer research and marketing engagement system. For instance, an automobile may include an embedded sensor that detects velocity and direction and an embedded GPS device that requests and receives location information from a GPS satellite, thereby allowing the customer research and marketing engagement system to determine appropriate engagement opportunities for the user by businesses or companies at a location where the user is heading.

In some embodiments, the customer research and marketing engagement system integrates all permitted and retrieved data/information into the SP associated with the user. In some embodiments, the integration of information and data occurs in real-time. In some embodiments, the sensor/device data and information is streamed in real-time to the system for contemporaneous integration in the SP of the user. In other embodiments, the sensor/device data and information is stored locally on a storage device until the system can be accessed by the machine, appliance, automobile, etc., to which the sensor/device data and information corresponds.

In addition to the example sensors noted above (velocity, direction sensors), many other sensors or devices can be used to gather information or data and engage with the system for integration of the data/information with the SP of the user. Other such sensors, devices, and components for extracting and obtaining information and data include, without limitation, altitude sensors, sound detection sensors and audio capture devices, visual detection sensors and image or video capture devices, etc.

Accordingly, the customer research and marketing engagement system of some embodiments captures, processes, and stores data from objects including video, images, smart images (e.g., 2- and 3-dimensional bar codes), radio frequency signals (e.g., RF tags), sonic signals (e.g., ultrasound), laser-data signals and other optical, electrical, mechanical, or wireless signals or objects.

In some embodiments, the customer research and marketing engagement system includes a cognitive and predictive analytics-driven marketing service which performs predictive analytics to match the user's SP with context-relevant offers from businesses or companies. In some embodiments, the cognitive and predictive analytics-driven marketing service is a cognitive learning engine that is implemented as a cognitive and predictive analytics software engine that provides functions of the cognitive and predictive analytics-driven marketing service when running on a computing device. In some embodiments, the customer research and marketing engagement system filters the offers from businesses or companies to derive a set of offers that are only from businesses or companies who have purchased licenses for using the user information in research, marketing, or other approved communications activities.

In some embodiments, the offer matching operations and filtering operations of the customer research and marketing engagement system are based on a cognitive learning engine that performs one or more advanced predictive algorithms that are implemented by the cognitive and predictive analytics software engine and performed by the cognitive and predictive analytic-driven marketing service. Being based on a cognitive learning engine that performs advanced predictive algorithms, the offer matching and filtering operations are performed in view of detailed user historical data and streaming real-time information. In this way, the customer research and marketing engagement system of some embodiments is able to create success propensity scores and other metrics needed for optimizing interactions with users. This underscores the cognitive learning aspect of the cognitive and predictive analytic-driven marketing service, whereby each successive user interaction and data point collected by the customer research and marketing engagement system directly or indirectly increases an understanding of the user's persona, interests, etc., as reflected in their SP. Overall, this improves the performance of predictive scores, the success rate for engagements, and the user's ability to earn additional income for their time.

In some embodiments, the customer research and marketing engagement system includes several other key platform components for enabling user account management, business, company, vendor, or sponsor account management, and administration of the system. Specifically, the customer research and marketing engagement system of some embodiments enables users to download and install the software application (or mobile app) that implements the method for increasing earnings opportunities of consumers, register and manage their personal information, configure the vendor engagement settings of their engagement profile, broadcast their unique personas (SP and personal information) when those users are ready to engage and interact with businesses, companies, or vendors to earn income or purchase products or services, engage with and interact with businesses, companies, or vendors via offers received from businesses, companies, or vendors, earn money or otherwise receive compensation, spend money, and manage their account.

In some embodiments, the customer research and marketing engagement system enables vendors or sponsors to configure their accounts, create campaigns, upload and manage offers, manage their budgets, track progress, validate user interactions, compensate users or otherwise pay bills, and in general, get the value that the vendors or sponsors are paying for.

In some embodiments, the customer research and marketing engagement system includes one or more key components that provide administrative tools for managing the customer research and marketing engagement system, including tools for controlling user rights, tools for managing user compensation financing, cognitive and predictive analytics tools for optimizing user interactions, and tools for maintaining the return on investment (ROI) obtained by all parties engaged in the system.

The powerful cognitive and predictive analytic-driven marketing service implements dozens of predictive algorithms in the cognitive and predictive analytics software engine that include sophisticated logic and subroutines which enable the customer research and marketing engagement system to provide several benefits to users, vendors, and sponsors of the system. For instance, the cognitive and predictive analytics software engine enables the customer research and marketing engagement system to identify several benefits, perform operations, and provide recommendations, including, without limitation, (i) providing a recommended ideal offer to present to a specific consumer in a particular location at a certain day and time, (ii) providing a recommended ideal channel or sequence of channels through which to interact with the consumer for particular offers at a certain time, (iii) providing a recommended ideal sequence of offers to present to consumers in order to optimize the results of interactions, (iv) providing a recommended best rate for a consumer to charge for engaging with businesses based on their individual profile characteristics, (v) providing a recommendation of ideal target consumers for a specific business offer, in a particular location, at a certain time in order to optimize business ROI, (vi) performing calculations for earned payments to be credited to the correct consumer account and debited from the appropriate vendor or sponsor account, and (vii) providing an identified next-best offer and channel logic for continuing a consumer (user) engagement based on the user's interaction history, personal profile, demographics and other information in their SP.

To make the customer research and marketing engagement system and the method for increasing earnings opportunities of consumers of the present disclosure, a person or a team of people working together may design, code, and build software applications that run on user computing devices (e.g., mobile apps that run on a mobile device of a user) and software applications that run on server-side computing devices in a networked architecture for the system. For instance, the software applications may implement parts of the method for increasing earnings opportunities of consumers and the customer research and marketing engagement system may be deployed with a cloud-based software as a service (SaaS) or platform as a service (PaaS) network architecture. Thus, the customer research and marketing engagement system and the method for increasing earnings opportunities of consumers include computer hardware resources, network communication resources, and software solutions that work together in a digital platform created by software developers, database managers, solution architects, analytics experts, predictive modelers, testers, integrators, platform security and privacy experts and other experts, who each contribute to the digital platform by performing a specific series of iterative and parallel tasks.

By way of example, FIG. 11 conceptually illustrates a network architecture of a customer research and marketing engagement system 1100 that hosts a cloud-based consumer information payment and configuration platform as a service (PaaS). As shown in this figure, the customer research and marketing engagement system 1100 includes a set of client computing devices 1110-1140, a wireless communication point 1122 (e.g., a cell tower for cellular data communication), a gateway 1124, a customer research and marketing engagement PaaS server computing devices 1150, a web database 1160, and a set of backend P2KM servers and the OELE 1140.

The software applications and computer programs which implement the method for increasing earnings opportunities of consumers include a family of downloadable mobile apps and software applications with front end access via Internet portals. To effectively carry out the operations of the method, several features or modules may be developed and integrated in the software, including (i) a tracker blocking and engagement module which enables users to block and/or engage with parties syndicating their data, (ii) a mobile wallet and payments module which enables users to earn and spend money with the app, (iii) a live research engine which enables direct, real-time engagement with users, (iv) one or more predictive engagement models which enable continuous improvement of user engagement, (v) an autonomous earnings and savings agent which enables automatic machine-to-machine earnings and savings, (vi) one or more exposable web services which enable API access to services and data, (vii) licensee and consumer account management modules which enable user, vendor, and sponsor account management, (viii) a delivery agent and rules for delivering relevant sponsored offers to users, (ix) a set of data privacy and channel access tools of an engagement profile management module which allows users to configure data access/privacy for data they will share and in which contexts, (x) a set of data pricing and licensing tools of the engagement profile management module which allows users to set pricing and licensing rules for data, (xi) a set of consumer access scheduling tools of the engagement profile management module which enables user control of when channel access is provided, (xii) an account administration module that enables management of app and platform settings, and (xiii) a set of secure access modules and subroutines which enable secure access, usage, data privacy and fraud prevention.

A variety of users interact with the customer research and marketing engagement system, including consumer users, vendor users (such as business users, company users, and sponsor users), and administration users. In particular, consumer users may interact with the system by managing personal data and information, configuring settings in their engagement profile, and monitoring vendor licensee access and payments (e.g., businesses and companies who pay a user-specified rate to obtain or use a consumer's personal information for purposes of marketing, research, or in-store engagement). Consumer users can then use the customer research and marketing engagement system to earn money and significant savings on purchases from the personal data they generate by using the software app to manage access to their personal data by vendors for purposes of marketing, research, and in-store engagement. Consumer users can also use the customer research and marketing engagement system to (i) prevent unauthorized access to their personal data by, for example, blocking trackers across all digital channels (e.g., toggling off the live broadcast mode), (ii) take charge of their digital personas through a single portal access point (e.g., the consumer's SP) to ensure that the information about them including interests, behaviors, demographics, econometrics and more is continually up-to-date, (iii) reduce irrelevant communications from businesses across all communications channels by ensuring that businesses have more complete access to their information, and (iv) earn money and optimize savings automatically on purchases by using an autonomous persona agent of the customer research and marketing engagement system.

Vendor users may interact with the customer research and marketing engagement system by customizing the app for their users with specific capabilities, branding, user options, etc., by searching for consumers in specific demographic groups or satisfying certain vendor-specified features, by licensing personal information of consumers for use in research, marketing, support, and other business purposes, and by compensating consumers for licensed access to their personal data. Vendor users can then use the customer research and marketing engagement system to (i) gain more predictable and complete access to more comprehensive, relevant and up-to-date consumer data, (ii) lower their cost and increase the ROI of direct engagement with consumers, and (iii) leverage state of-the-art mobile app capabilities including mobile wallets, cognitive computing, advanced web services, cumulative insight optimized research, cross-chapel coordination.

In addition, the mobile wallet and syndicated persona database of consumer insights of the customer research and marketing engagement system can be used inside of other applications and devices to enrich the offerings and relevance of non-competing apps. For example, consumer users can be enabled to spend their earnings inside of other solutions to purchase products and services. Additionally, the information contained in the SP of a consumer user can be licensed by other applications and businesses to improve the contextual relevance (and ROI) of their solutions. Furthermore, the customer research and marketing engagement system enables consumer users to earn money and optimize savings automatically on purchases by way of the autonomous persona agent. The consumer SP of the customer research and marketing engagement system can be used to produce an intelligent agent that works and acts on behalf of the human consumer to negotiate payments and discounts automatically without the consumer's deliberate and direct effort.

Administration users may interact with the customer research and marketing engagement system by managing vendors and users, monitoring security, fraud, and privacy, and providing overall administration.

### V. Electronic System

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

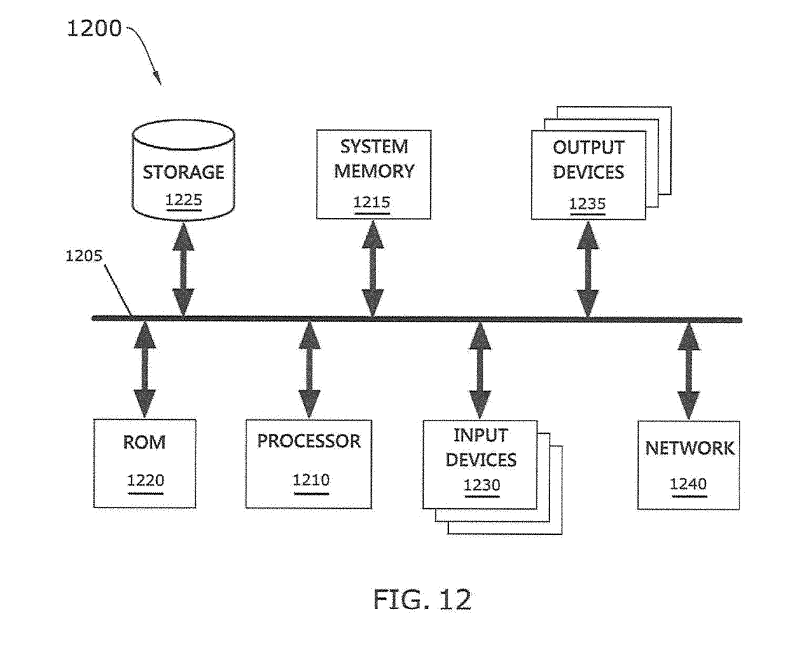

FIG. 12 conceptually illustrates an electronic system 1200 with which some embodiments of the invention are implemented. The electronic system 1200 may be a computer, phone, PDA, or any other sort of electronic device. Such an electronic system includes various types of computer readable media and interfaces for various other types of computer readable media. Electronic system 1200 includes a bus 1205, processing unit(s) 1210, a system memory 1215, a read-only 1220, a permanent storage device 1225, input devices 1230, output devices 1235, and a network 1240.

The bus 1205 collectively represents all system, peripheral, and chipset buses that communicatively connect the numerous internal devices of the electronic system 1200. For instance, the bus 1205 communicatively connects the processing unit(s) 1210 with the read-only 1220, the system memory 1215, and the permanent storage device 1225.

From these various memory units, the processing unit(s) 1210 retrieves instructions to execute and data to process in order to execute the processes of the invention. The processing unit(s) may be a single processor or a multi-core processor in different embodiments.

The read-only-memory (ROM) 1220 stores static data and instructions that are needed by the processing unit(s) 1210 and other modules of the electronic system. The permanent storage device 1225, on the other hand, is a read-and-write memory device. This device is a non-volatile memory unit that stores instructions and data even when the electronic system 1200 is off. Some embodiments of the invention use a mass-storage device (such as a magnetic or optical disk and its corresponding disk drive) as the permanent storage device 1225.

Other embodiments use a removable storage device (such as a floppy disk or a flash drive) as the permanent storage device 1225. Like the permanent storage device 1225, the system memory 1215 is a read-and-write memory device. However, unlike storage device 1225, the system memory 1215 is a volatile read-and-write memory, such as a random access memory. The system memory 1215 stores some of the instructions and data that the processor needs at runtime. In some embodiments, the invention's processes are stored in the system memory 1215, the permanent storage device 1225, and/or the read-only 1220. For example, the various memory units include instructions for processing appearance alterations of displayable characters in accordance with some embodiments. From these various memory units, the processing unit(s) 1210 retrieves instructions to execute and data to process in order to execute the processes of some embodiments.

The bus 1205 also connects to the input and output devices 1230 and 1235. The input devices enable the user to communicate information and select commands to the electronic system. The input devices 1230 include alphanumeric keyboards and pointing devices (also called “cursor control devices”). The output devices 1235 display images generated by the electronic system 1200. The output devices 1235 include printers and display devices, such as cathode ray tubes (CRT) or liquid crystal displays (LCD). Some embodiments include devices such as a touchscreen that functions as both input and output devices.

Finally, as shown in FIG. 12, bus 1205 also couples electronic system 1200 to a network 1240 through a network adapter (not shown). In this manner, the computer can be a part of a network of computers (such as a local area network (“LAN”), a wide area network (“WAN”), or an intranet), or a network of networks (such as the Internet). Any or all components of electronic system 1200 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 1-4 conceptually illustrate processes in which the specific operations of each process may not be performed in the exact order shown and described. Specific operations may not be performed in one continuous series of operations, and different specific operations may be performed in different embodiments. Furthermore, each process could be implemented using several sub-processes, or as part of a larger macro process. Thus, one of ordinary skill in the art would understand that the invention is not to be limited by the foregoing illustrative details, but rather is to be defined by the appended claims.

I claim:

1. A customer research and marketing engagement system comprising:
a personal data marketing disintermediation service that enables a consumer to configure engagement settings and personal data access rules, rates, and schedules that manage vendor access to consumer personal data, wherein the personal data marketing disintermediation service associates the consumer with a holistic consumer identity comprising an electronic mobile wallet, an engagement profile comprising the engagement settings and personal data access rules, rates, and schedules, and a syndicated persona (SP) which the consumer can license to vendors for a recurring source of income;
a cognitive and predictive analytics-driven marketing service that performs predictive analytics to match the consumer's SP with context-relevant offers from vendors; and
a cross-channel marketing and payments operations integration service which enables users to earn money from vendors who pay for licensed access of the personal information, to store the earned money in a secure stored value payment device, and to spend earned money through any of several marketplace channels.

2. The customer research and marketing engagement system of claim 1, wherein the engagement settings comprise a plurality of communication channels by which vendors communicate with the consumer.

3. The customer research and marketing engagement system of claim 1, wherein rates for consumer data access are configured by data source.

4. The customer research and marketing engagement system of claim 1, wherein rates for consumer engagement are configured by schedule.

5. The customer research and marketing engagement system of claim 1, wherein the cognitive and predictive analytics-driven marketing service presents context-relevant offers from vendors to the consumer for one of acceptance and non-acceptance of each context relevant offer.

6. The customer research and marketing engagement system of claim 5, wherein the cognitive and predictive analytics-driven marketing service presents the context-relevant offers from vendors in a sequence that optimizes a likelihood of engagement by the consumer with a presented context-relevant offer.

7. A non-transitory computer readable medium storing a program which when executed by at least one processing unit of a computing device increases earning opportunities of a consumer, the program comprising sets of instructions for:
creating a syndicated persona of the consumer from user-provided information;
searching for offers to present to the consumer;
identifying offers that are relevant to the syndicated profile of the consumer;
presenting the identified relevant offers to the consumer; and
authorizing payment to the consumer for any completed engagement related to at least one of the identified relevant offers.

8. The non-transitory computer readable medium of claim 7, wherein the program further comprises sets of instructions for:
determining whether a particular identified relevant offer presented to the consumer is accepted by the consumer; and
when the particular identified relevant offer is accepted by the consumer, validating the particular identified relevant offer as a completed engagement before authorizing payment to the consumer in relation to the particular identified relevant offer.

9. The non-transitory computer readable medium of claim 7, wherein the user-provided information comprises profile information pertaining to the consumer and configuration settings, wherein the configuration settings comprise one or more communication channels, one or more scheduled times during which the consumer is available for engagement, and at least one pay rate to be paid for engagement with a vendor during the scheduled time.

10. The non-transitory computer readable medium of claim 9, wherein the set of instructions for creating the syndicated persona comprise a set of instructions adding the profile information, the communication channels, the scheduled times, and the pay rate to the syndicated persona.
